(19) United States
(12) Patent Application Publication
(10) Pub. No.: US 2014/0002492 A1
(43) Pub. Date: Jan. 2, 2014

(54) PROPAGATION OF REAL WORLD PROPERTIES INTO AUGMENTED REALITY IMAGES

(71) Applicants: Mathew J. Lamb, Mercer Island, WA (US); Ben J. Sugden, Woodinville, WA (US); Robert L. Crocco, JR., Seattle, WA (US); Brian E. Keane, Bellevue, WA (US); Christopher E. Miles, Seattle, WA (US); Kathryn Stone Perez, Kirkland, WA (US); Laura K. Massey, Redmond, WA (US); Alex Aben-Athar Kipman, Redmond, WA (US); Tom G. Salter, Seattle, WA (US)

(72) Inventors: Mathew J. Lamb, Mercer Island, WA (US); Ben J. Sugden, Woodinville, WA (US); Robert L. Crocco, JR., Seattle, WA (US); Brian E. Keane, Bellevue, WA (US); Christopher E. Miles, Seattle, WA (US); Kathryn Stone Perez, Kirkland, WA (US); Laura K. Massey, Redmond, WA (US); Alex Aben-Athar Kipman, Redmond, WA (US); Tom G. Salter, Seattle, WA (US)

(21) Appl. No.: 13/538,691

(22) Filed: Jun. 29, 2012

(51) Int. Cl. G09G 5/00

(52) U.S. Cl. 345/633

(57) ABSTRACT

Techniques are provided for propagating real world properties into mixed reality images in a see-through, near-eye mixed reality display device. A physical property from the real world may be propagated into a virtual image to be rendered in the display device. Thus, the physics depicted in the mixed reality images may be influenced by a physical property in the environment. Therefore, the user wearing the mixed reality display device is provided a better sense that it is mixed reality, as opposed to simply virtual reality. The mixed reality image may be linked to a real world physical object. This physical object can be movable such as a book, paper, cellular telephone, etc. Forces on the physical object may be propagated into the virtual image.

### BACKGROUND

Virtual reality is a technology that presents virtual imagery in a display without an augmentation to reality.

Augmented or mixed reality is a technology that allows virtual imagery to be mixed with a user's actual view of the real world. A see-through, near-eye mixed reality display may be worn by a user to view the mixed imagery of virtual and real objects. The display presents virtual imagery in the user's field of view.

A problem with augmented or mixed reality is that the viewer sometimes does not get the sense that reality is being augmented. Rather, the mixed reality experience ends up being more of a virtual reality experience.

### SUMMARY

Techniques are provided for propagating real world properties into mixed reality images in a see-through, near-eye mixed reality display device. The physics of the mixed reality images may be tied to a physical property in the environment. Therefore, the user wearing the mixed reality display device is provided a better sense that it is mixed reality, as opposed to simply virtual reality.

One embodiment includes a method for rendering a virtual image in a see-through, near-eye mixed reality display device such that a physical property from the real world is propagated into the virtual image. The method includes determining a physical property based on sensor data, and applying the physical property to a virtual image. The virtual image is modified in response to applying the physical property. The modified virtual image is rendered in a see-through, near-eye, mixed-reality display device.

One embodiment includes a display system for rendering a virtual image in a see-through, near-eye mixed reality display device such that a physical property from the real world is propagated into the virtual image. The system comprises a see-through, near-eye mixed reality display device, and logic in communication with the display device. The logic is configured to determine a physical property based on sensor data. The logic is configured propagate the physical property to an augmented reality scene. The logic is configured to modify the augmented reality scene based on the propagated physical property. The logic is configured to render the modified augmented reality scene in the see-through, near-eye, mixed-reality display device.

One embodiment includes a method for modifying a virtual image in a head mounted display device based on a physical property from the real world that is propagated into the virtual image. An augmented reality scene is rendered in a head mounted display device. The augmented reality scene is associated with a real world object. Sensor data of an environment of the head mounted display device is accessed. Based on the sensor data, a physical force that affects the real world object is determined. The physical force is propagated to the augmented reality scene. The augmented reality scene is modified due to the propagated physical force. The modified augmented reality scene is rendered in the head mounted display device.

This summary is provided to introduce a selection of concepts in a simplified form that are further described below in the description. This summary is not intended to identify key features or essential features of the claimed subject matter, nor is it intended to be used to limit the scope of the claimed subject matter.

### BRIEF DESCRIPTION OF THE DRAWINGS

In the drawings, like-numbered elements correspond to one another.

FIG. 1A, FIG. 1B, and FIG. 1C show an augmented reality scene that rendered based on a real world physical property.

FIG. 2A, FIG. 2B, and FIG. 2C show an augmented reality scene that rendered based on a real world physical property.

FIG. 3 is a diagram depicting example components of one embodiment of an HMD device.

FIG. 4 is a top view of a portion of one embodiment of a HMD device.

FIG. 5 is a block diagram of one embodiment of the components of a HMD device.

FIG. 6 is a block diagram of one embodiment of the components of a processing unit associated with a HMD device.

FIG. 7 is a block diagram of one embodiment of the components of a hub computing system used with a HMD device.

FIG. 8 is a block diagram of one embodiment of a computing system that can be used to implement the hub computing system described herein.

FIG. 9 is a flowchart of one embodiment of a process of rendering a virtual image in a see-through, near-eye, mixed reality display device.

FIG. 10 is a flowchart of one embodiment of a process of rendering a virtual image based on its connection to a real world physical object.

FIG. 11 is a flowchart of one embodiment of a process of determining how gravity in the environment will affect physics of a virtual image that is linked to a real world object.

FIG. 12A is a flowchart of one embodiment of a process of determining how forces on the real world object due to movement of the object will affect physics of the virtual image.

FIG. 12B is a diagram of one embodiment of applying forces from a real world object to a virtual image.

FIG. 13 is one embodiment of a flowchart of a process of rendering a virtual image based on a physical simulation that uses a real world physical property as an input.

FIG. 14 is a flowchart of one embodiment of a process of rendering a virtual image in which different branches are taken depending on a physical property in the environment.

FIG. 15 is a flowchart of one embodiment of a process of determining an effect of temperature on a virtual image.

FIG. 16 is a flowchart of one embodiment of a process of determining an effect of a light intensity on a virtual image.

FIG. 17 is a flowchart of one embodiment of a process of determining an effect of a wind on a virtual image.

### DETAILED DESCRIPTION

Techniques are provided for rendering mixed reality images in a head mounted display, such as a see-through, near-eye mixed reality display device. A physical property from the real world may be propagated into a virtual image to be rendered in the display device. Thus, the physics depicted in the mixed reality images may be influenced by a physical property in the environment. Therefore, the user wearing the mixed reality display device is provided a better sense that it is mixed reality, as opposed to simply virtual reality.

In one embodiment, the mixed reality image is linked to a real world physical object. This object can be movable such as a book, paper, cellular telephone, etc. As one example, the mixed reality image is linked to a surface of the real world object. Thus, if the surface is moved, this is propagated to the virtual image such that there will be an impact to the physics depicted in the mixed reality image. A physical property that affects the real world object may be applied to the mixed reality image. For example, if the object is turned from one side to another, then the gravity vector affecting the surface that is linked to the mixed reality image changes direction. This change in the gravity vector may be applied to the mixed reality image. Many other possibilities exist.

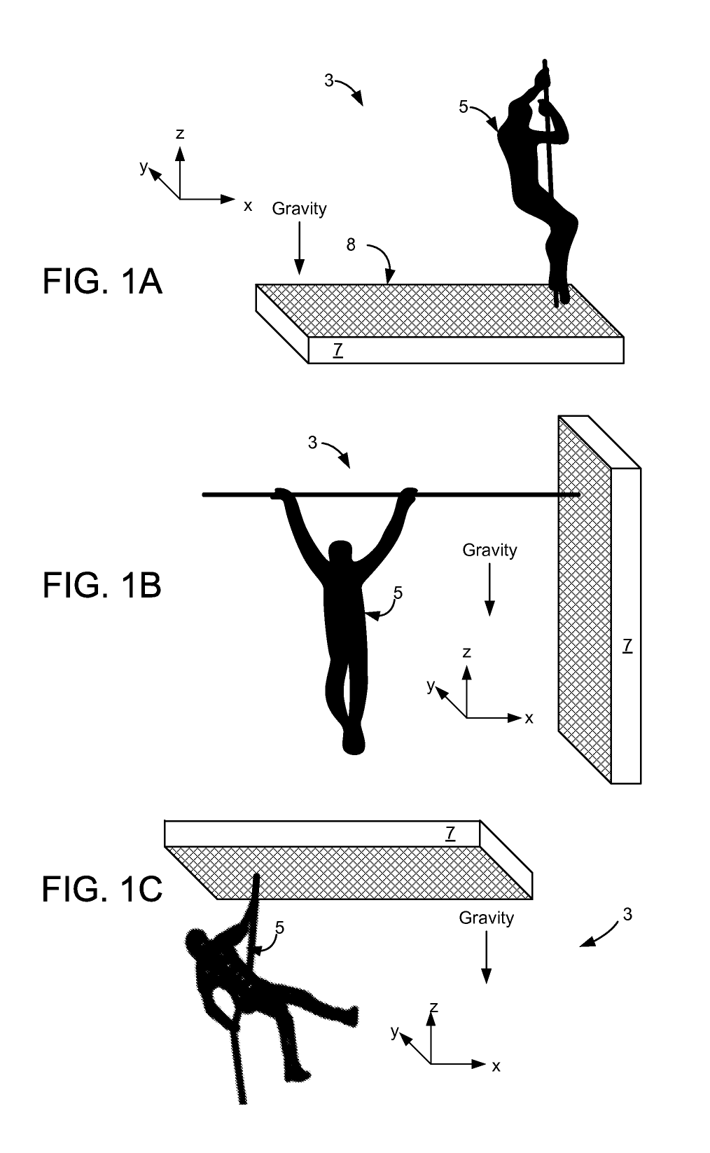

FIG. 1A, FIG. 1B, and FIG. 1C are diagrams representing a mixed reality image 3 that includes a virtual image 5 and a real world object 7. The virtual image 5 is rendered in a mixed reality display device. In this example, the virtual image 5 is a person traversing a rope. In this example, the virtual image 5 is associated with some real world object 7. The real world object 7 could be any object such as a book, paper, cellular telephone, etc. The virtual image 5 is rendered in a mixed reality display device such that its physics are impacted by some physical property in the real world.

The real world object 7 has a surface 8. In FIG. 1A, the surface is aligned with the x-y plane with a normal to the surface pointing in the positive z-direction. In FIG. 1B, the surface is aligned with the y-z plane with a normal to the surface pointing in the negative x-direction. In FIG. 1C, the surface is aligned with the x-y plane with a normal to the surface pointing in the negative z-direction. In each case, the gravity vector is pointing downward, in the negative z-direction.

The virtual image 5 is associated with the surface 8 in this example. In one embodiment, the real world object 7 has a tag or other marker that is used to determine where the virtual image 5 should be located. In this example, the virtual image 5 is tied to the surface 8, such that as the surface 8 is moved the virtual image 5 also moves. However, the real world gravity is used to alter the physics depicted in the virtual image 5. The virtual image 5 changes depending on a physical property that is sensed in the environment near the mixed reality display device.

For example, in FIG. 1A, the person is climbing up the rope. In FIG. 1B, the person is moving along the rope from right to left. In FIG. 1C, the person is repelling down the rope. Note that in this example, there is a common theme of the person always moving away from the surface 8. However, there is a change to the storyline based on a real word physical property, which in this example is gravity.

Note that there may be some underlying physics associated with the virtual image 5 of FIGS. 1A-1C. For example, although the person and rope are just a virtual image they may be intended to have or represent physical properties that a real world person traversing a rope would have. For example, a person has mass, which is impacted by gravity. Propagating the physical property to the virtual image 5 may be considered to be applying the physical property to physics of the virtual image. By the physics of the virtual image it is meant the physics being represented or simulated in the virtual image.

In this example, a portion of the virtual image 5 is made to appear to a person wearing the mixed reality display device as though it is touching the surface 8. Note that is it not required for the virtual image 5 to appear to be touching the real world object 7 upon which the physical property may be derived. For example, the virtual image 5 could be rendered such that it appears to be on a table, instead of on the surface 8 of the real world object 7. Also note that the physical property need not be derived from a real world object 7 that is associated with the virtual image 5. For example, temperature and light intensity are physical properties that are not necessarily derived from a real world object 7 such as a book associated with the virtual image 5.

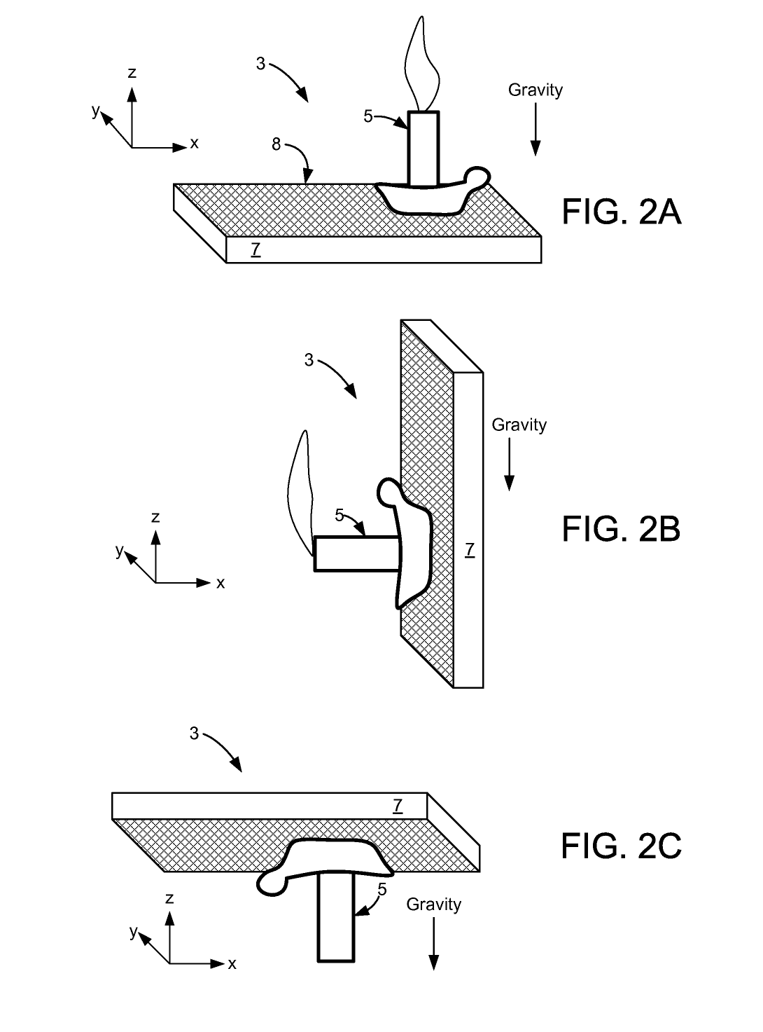

FIG. 2A, FIG. 2B, and FIG. 2C are diagrams representing another example of a mixed reality image 3 that includes a virtual image 5 and a real world object 7. In this example, the virtual object 5 is a candle. The real world object 7 could be any object such as a book, paper, cellular telephone, etc. The virtual image 5 is rendered in a mixed reality display device such that the physics of the virtual image 5 is impacted by a physical property in the real world, in accordance with one embodiment.

The real world object 7 has a surface 8. In FIG. 2A, the surface is aligned with the x-y plane with a normal to the surface pointing in the positive z-direction. In FIG. 2B, the surface is aligned with the y-z plane with a normal to the surface pointing in the negative x-direction. In FIG. 2C, the surface is aligned with the x-y plane with a normal to the surface pointing in the negative z-direction. In each case, the gravity vector is pointing downward, in the negative z-direction.

In this example, the gravity vector is propagated to the virtual image 5. In FIG. 2A, the candle flame is pointing in the positive z-direction, away from the gravity vector. In FIG. 2B, the candle flame is again pointing in the positive z-direction, away from the gravity vector. However, now the candle stick is pointing in the negative x-direction. Note that the candle stick's position has remained constant with respect to the surface 8 in this example. In FIG. 2C, the candle stick is now upside down. The physical property of the gravity vector has been propagated to the virtual image 5, wherein the candle flame is now extinguished. By propagating or otherwise applying a physical property to the virtual image 5, the user gets a better sense of mixed reality.

Note that there may be some underlying physics associated with the virtual image 5 of FIGS. 2A-2C. For example, although the candle flame is just a virtual image it may be intended to have physical properties that a real world candle would have. In one embodiment, the candle and flame are a physics simulation. In one embodiment, a physical simulation uses one or more parameters (e.g., a force vector such as a gravity vector) as input. In one embodiment, a real world physical property is input as a parameter to a physics simulation. Propagating the physical property to the virtual image 5 may be considered to be applying the physical property to physics of the virtual image.

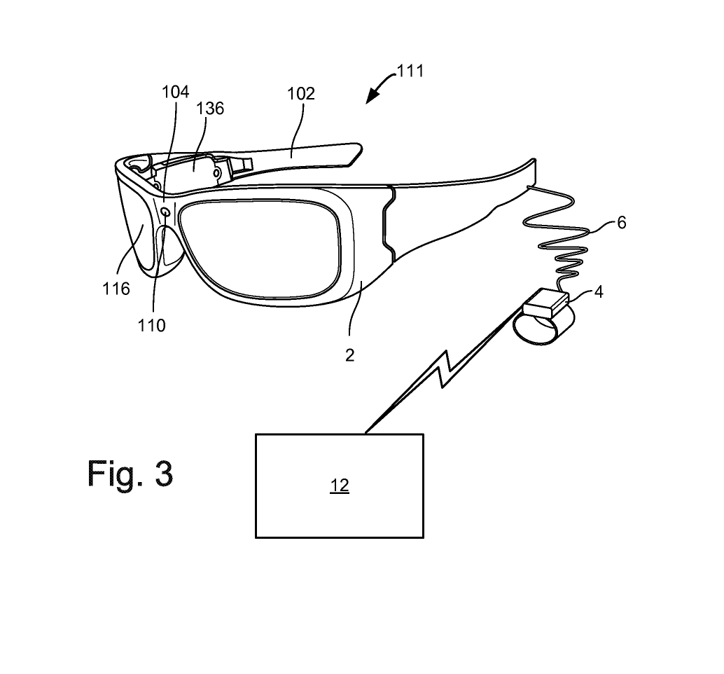

FIG. 3 shows further details of one embodiment of an HMD system 111. The HMD system 111 includes an HMD device 2 in communication with processing unit 4 via wire 6. In other embodiments, HMD device 2 communicates with processing unit 4 via wireless communication. Note that the processing unit 4 could be integrated into the HMD device 2. Head-mounted display device 2, which in one embodiment is in the shape of glasses, including a frame with see-through lenses, is carried on the head of a person so that the person can see through a display and thereby see a real-world scene which includes an image which is not generated by the HMD device. More details of the HMD device 2 are provided below.

In one embodiment, processing unit 4 is carried on the user's wrist and includes much of the computing power used to operate HMD device 2. Processing unit 4 may communicate wirelessly (e.g., using WIFI®, Bluetooth®, infrared (e.g., IrDA or Infrared Data Association standard), or other wireless communication means) to one or more hub computing systems 12.

In one embodiment, hub computing system 12 may include a processor such as a standardized processor, a specialized processor, a microprocessor, or the like that may execute instructions stored on a processor readable storage device for performing the processes described herein.

Processing unit 4 and/or hub computing device 12, may be used to recognize, analyze, and/or track human (and other types of) targets. For example, the position of the head of the person wearing HMD device 2 may be tracked to help determine how to present virtual images in the HMD 2.

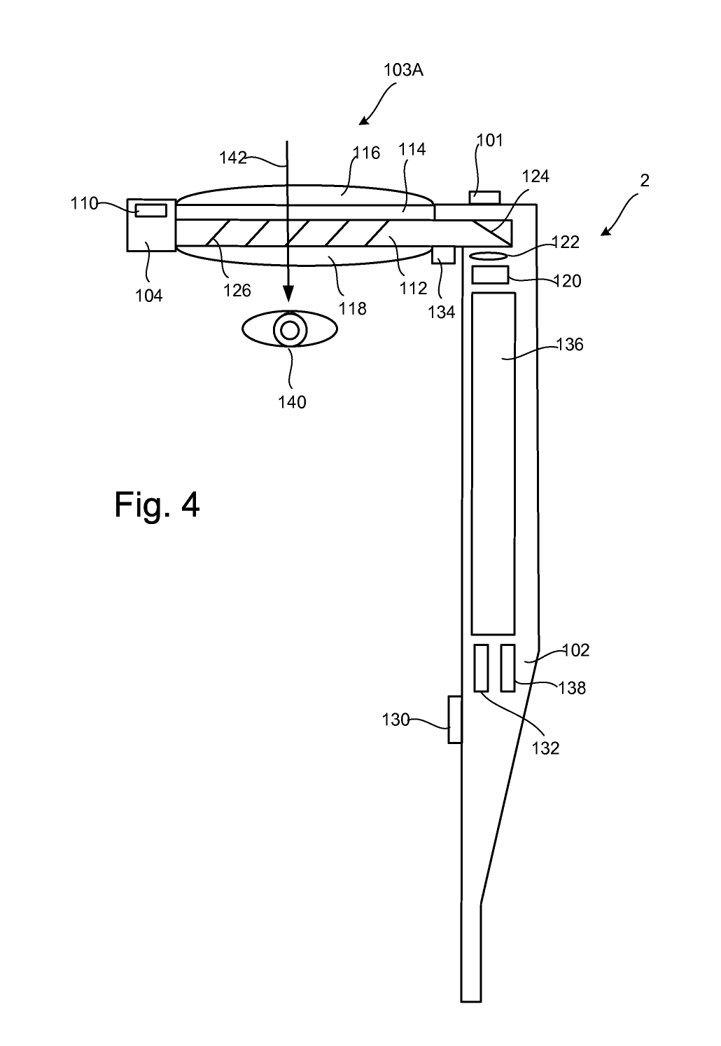

FIG. 4 depicts a top view of a portion of one embodiment of HMD device 2, including a portion of the frame that includes temple 102 and nose bridge 104. Only the right side of HMD device 2 is depicted. Built into nose bridge 104 is a microphone 110 for recording sounds and transmitting that audio data to processing unit 4, as described below. At the front of HMD device 2 is room-facing camera 101 that can capture image data. This image data could be used to form a depth image. The room-facing camera 101 could project IR and sense reflected IR light from objects to determine depth. The room-facing video camera 101 could be an RGB camera. The images may be transmitted to processing unit 4 and/or hub computing device 12. The room-facing camera 101 faces outward and has a viewpoint similar to that of the user.

A portion of the frame of HMD device 2 will surround a display 103A (that includes one or more lenses). In order to show the components of HMD device 2, a portion of the frame surrounding the display is not depicted. In this embodiment, the display 103A includes a light guide optical element 112 (or other optical element), opacity filter 114, see-through lens 116 and see-through lens 118. In one embodiment, opacity filter 114 is behind and aligned with see-through lens 116, light guide optical element 112 is behind and aligned with opacity filter 114, and see-through lens 118 is behind and aligned with light guide optical element 112. See-through lenses 116 and 118 may be standard lenses used in eye glasses and can be made to any prescription (including no prescription). In one embodiment, see-through lenses 116 and 118 can be replaced by a variable prescription lens. In some embodiments, HMD device 2 will include only one see-through lens or no see-through lenses. In another alternative, a prescription lens can go inside light guide optical element 112. Opacity filter 114 filters out natural light (either on a per pixel basis or uniformly) to enhance the contrast of the virtual imagery. Light guide optical element 112 channels artificial light to the eye. More details of opacity filter 114 and light guide optical element 112 are provided below.

Mounted to or inside temple 102 is an image source, which (in one embodiment) includes microdisplay 120 for projecting a virtual image and lens 122 for directing images from microdisplay 120 into light guide optical element 112. In one embodiment, lens 122 is a collimating lens. A remote display device can include microdisplay 120, one or more optical components such as the lens 122 and light guide 112, and associated electronics such as a driver. Such a remote display device is associated with the HMD device, and emits light to a user's eye, where the light represents the physical objects that correspond to the electronic communications.

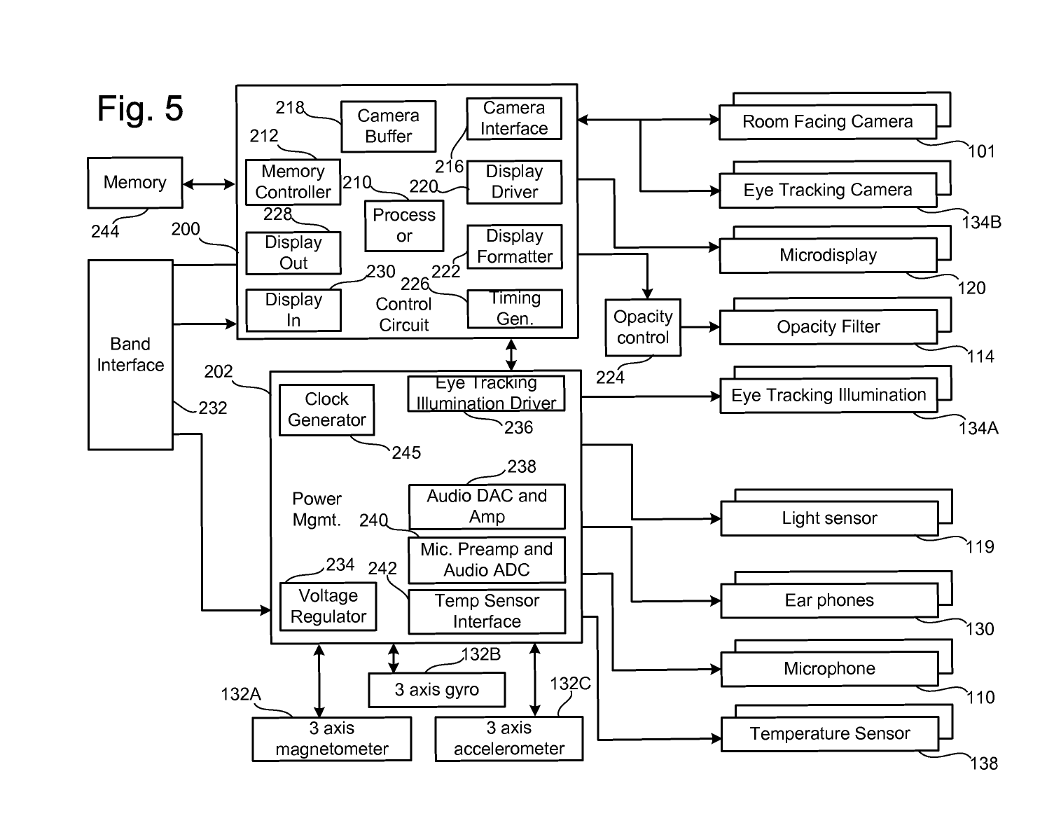

Control circuits 136 provide various electronics that support the other components of HMD device 2. More details of control circuits 136 are provided below with respect to FIG. 5. Inside, or mounted to temple 102, are ear phones 130, inertial sensors 132 and temperature sensor 138. In one embodiment, inertial sensors 132 include a three axis magnetometer 132A, three axis gyro 132B and three axis accelerometer 132C (See FIG. 5). The inertial sensors are for sensing position, orientation, sudden accelerations of HMD device 2. For example, the inertial sensors can be one or more sensors which are used to determine an orientation and/or location of user's head.

Microdisplay 120 projects an image through lens 122. There are different image generation technologies that can be used to implement microdisplay 120. For example, microdisplay 120 can be implemented in using a transmissive projection technology where the light source is modulated by optically active material, backlit with white light. These technologies are usually implemented using LCD type displays with powerful backlights and high optical energy densities. Microdisplay 120 can also be implemented using a reflective technology for which external light is reflected and modulated by an optically active material. The illumination is forward lit by either a white source or RGB source, depending on the technology. Digital light processing (DLP), liquid crystal on silicon (LCOS) and MIRASOL® (a display technology from QUALCOMM, INC.) are all examples of reflective technologies which are efficient as most energy is reflected away from the modulated structure. Additionally, microdisplay 120 can be implemented using an emissive technology where light is generated by the display. For example, a PicoP™-display engine (available from MICROVISION, INC.) emits a laser signal with a micro mirror steering either onto a tiny screen that acts as a transmissive element or beamed directly into the eye (e.g., laser).

Light guide optical element 112 transmits light from microdisplay 120 to the eye 140 of the person wearing HMD device 2. Light guide optical element 112 also allows light from in front of the HMD device 2 to be transmitted through light guide optical element 112 to eye 140, as depicted by arrow 142, thereby allowing the person to have an actual direct view of the space in front of HMD device 2 in addition to receiving a virtual image from microdisplay 120. Thus, the walls of light guide optical element 112 are see-through. Light guide optical element 112 includes a first reflecting surface 124 (e.g., a mirror or other surface). Light from microdisplay 120 passes through lens 122 and becomes incident on reflecting surface 124. The reflecting surface 124 reflects the incident light from the microdisplay 120 such that light is trapped inside a planar, substrate comprising light guide optical element 112 by internal reflection. After several reflections off the surfaces of the substrate, the trapped light waves reach an array of selectively reflecting surfaces 126. Note that only one of the five surfaces is labeled 126 to prevent over-crowding of the drawing.

Reflecting surfaces 126 couple the light waves incident upon those reflecting surfaces out of the substrate into the eye 140 of the user. As different light rays will travel and bounce off the inside of the substrate at different angles, the different rays will hit the various reflecting surface 126 at different angles. Therefore, different light rays will be reflected out of the substrate by different ones of the reflecting surfaces. The selection of which light rays will be reflected out of the substrate by which surface 126 is engineered by selecting an appropriate angle of the surfaces 126. More details of a light guide optical element can be found in U.S. Patent Application Publication 2008/0285140, Ser. No. 12/214,366, published on Nov. 20, 2008, incorporated herein by reference in its entirety. In one embodiment, each eye will have its own light guide optical element 112. When the HMD device has two light guide optical elements, each eye can have its own microdisplay 120 that can display the same image in both eyes or different images in the two eyes. In another embodiment, there can be one light guide optical element which reflects light into both eyes. In one embodiment, a single microdisplay 120 and single light guide optical element 112 is able to display different images into each eye.

In some embodiments, the HMD has an opacity filter 114. Opacity filter 114, which is aligned with light guide optical element 112, selectively blocks natural light, either uniformly or on a per-pixel basis, from passing through light guide optical element 112. In one embodiment, the opacity filter can be a see-through LCD panel, electrochromic film, or similar device which is capable of serving as an opacity filter. Such a see-through LCD panel can be obtained by removing various layers of substrate, backlight and diffusers from a conventional LCD. The LCD panel can include one or more light-transmissive LCD chips which allow light to pass through the liquid crystal. Such chips are used in LCD projectors, for instance.

Opacity filter 114 can include a dense grid of pixels, where the light transmissivity of each pixel is individually controllable between minimum and maximum transmissivities. While a transmissivity range of 0-100% is ideal, more limited ranges are also acceptable. As an example, a monochrome LCD panel with no more than two polarizing filters is sufficient to provide an opacity range of about 50% to 90% per pixel, up to the resolution of the LCD. At the minimum of 50%, the lens will have a slightly tinted appearance, which is tolerable. 100% transmissivity represents a perfectly clear lens. An “alpha” scale can be defined from 0-100%, where 0% allows no light to pass and 100% allows all light to pass. The value of alpha can be set for each pixel by the opacity filter control circuit 224 described below. The opacity filter 114 may be set to whatever transmissivity is desired.

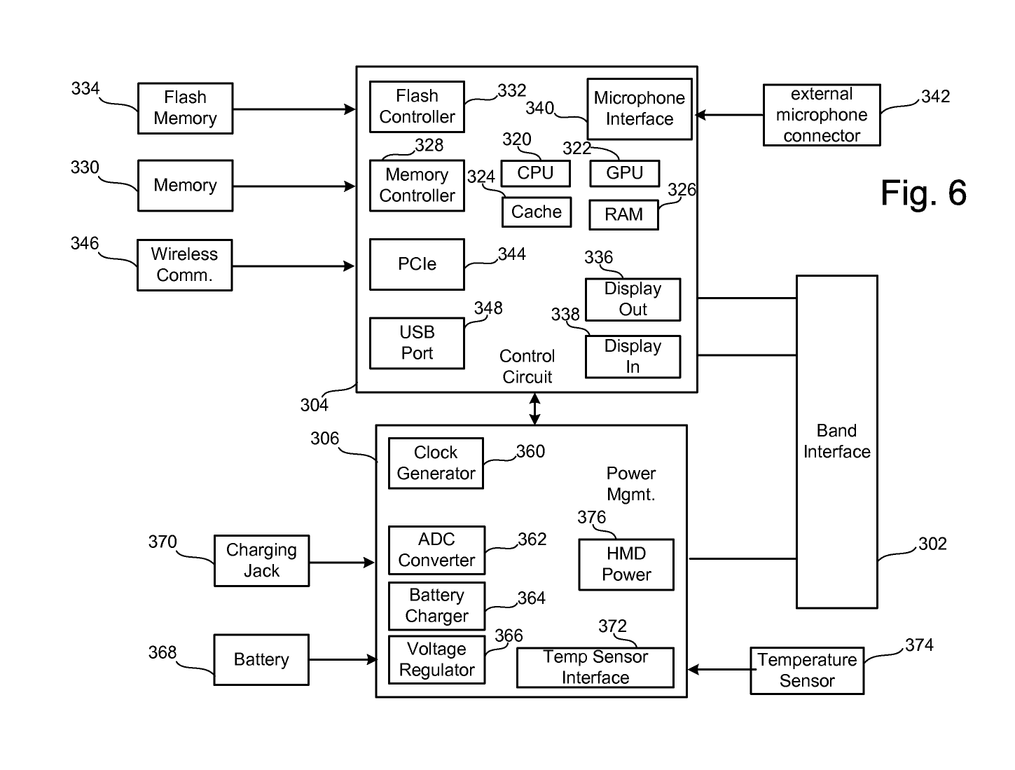

FIG. 5 is a block diagram depicting the various components of one embodiment of HMD device 2. FIG. 6 is a block diagram describing the various components of one embodiment of processing unit 4. Note that in some embodiments, the various components of the HMD device 2 and the processing unit 4 may be combined in a single electronic device. Additionally, the HMD device components of FIG. 5 include many sensors that track various conditions. Head-mounted display device may receive images from processing unit 4 and may provide sensor information back to processing unit 4. Processing unit 4, the components of which are depicted in FIG. 5, may receive the sensory information from HMD device 2 and also from hub computing device 12 (See FIG. 3).

Note that some of the components of FIG. 5 (e.g., room facing camera 101, eye tracking camera 134B, microdisplay 120, opacity filter 114, eye tracking illumination 134A, earphones 130, light sensor 119, and temperature sensor 138) are shown in shadow to indicate that there are two of each of those devices, one for the left side and one for the right side of HMD device. Regarding the room-facing camera 101, in one approach one camera is used to obtain images using visible light. In another approach, two or more cameras with a known spacing between them are used as a depth camera to also obtain depth data for objects in a room, indicating the distance from the cameras/HMD device to the object. The cameras of the HMD device can essentially duplicate the functionality of the depth camera provided by the computer hub 12.

FIG. 5 shows the control circuit 200 in communication with the power management circuit 202. Control circuit 200 includes processor 210, memory controller 212 in communication with memory 244 (e.g., DRAM), camera interface 216, camera buffer 218, display driver 220, display formatter 222, timing generator 226, display out interface 228, and display in interface 230. In one embodiment, all of components of control circuit 200 are in communication with each other via dedicated lines or one or more buses. In another embodiment, each of the components of control circuit 200 is in communication with processor 210. Camera interface 216 provides an interface to the two room facing cameras 112 and stores images received from the room facing cameras in camera buffer 218. Display driver 220 drives microdisplay 120. Display formatter 222 provides information, about the images being displayed on microdisplay 120, to opacity control circuit 224, which controls opacity filter 114. Timing generator 226 is used to provide timing data for the system. Display out interface 228 is a buffer for providing images from room facing cameras 112 to the processing unit 4. Display in 230 is a buffer for receiving images to be displayed on microdisplay 120. Display out 228 and display in 230 communicate with band interface 232 which is an interface to processing unit 4.

Power management circuit 202 includes voltage regulator 234, eye tracking illumination driver 236, audio DAC and amplifier 238, microphone preamplifier audio ADC 240, temperature sensor interface 242 and clock generator 245. Voltage regulator 234 receives power from processing unit 4 via band interface 232 and provides that power to the other components of HMD device 2. Eye tracking illumination driver 236 provides the infrared (IR) light source for eye tracking illumination 134A, as described above. Audio DAC and amplifier 238 receives the audio information from earphones 130. Microphone preamplifier and audio ADC 240 provides an interface for microphone 110. Temperature sensor interface 242 is an interface for temperature sensor 138. Power management unit 202 also provides power and receives data back from three-axis magnetometer 132A, three-axis gyroscope 132B and three axis accelerometer 132C.

FIG. 6 is a block diagram describing the various components of processing unit 4. Control circuit 304 is in communication with power management circuit 306. Control circuit 304 includes a central processing unit (CPU) 320, graphics processing unit (GPU) 322, cache 324, RAM 326, memory control 328 in communication with memory 330 (e.g., D-RAM), flash memory controller 332 in communication with flash memory 334 (or other type of non-volatile storage), display out buffer 336 in communication with HMD device 2 via band interface 302 and band interface 232, display in buffer 338 in communication with HMD device 2 via band interface 302 and band interface 232, microphone interface 340 in communication with an external microphone connector 342 for connecting to a microphone, PCI express interface 344 for connecting to a wireless communication device 346, and USB port(s) 348.

In one embodiment, wireless communication component 346 can include a WIFI® enabled communication device, Bluetooth communication device, infrared communication device, etc. The wireless communication component 346 is a wireless communication interface which, in one implementation, receives data in synchronism with the content displayed by the video display screen.

The USB port can be used to dock the processing unit 4 to hub computing device 12 in order to load data or software onto processing unit 4, as well as charge processing unit 4. In one embodiment, CPU 320 and GPU 322 are the main workhorses for determining where, when and how to render virtual images in the HMD.

Power management circuit 306 includes clock generator 360, analog to digital converter 362, battery charger 364, voltage regulator 366, HMD power source 376, and temperature sensor interface 372 in communication with temperature sensor 374 (located on the wrist band of processing unit 4). Analog to digital converter 362 is connected to a charging jack 370 for receiving an AC supply and creating a DC supply for the system. Voltage regulator 366 is in communication with battery 368 for supplying power to the system. Battery charger 364 is used to charge battery 368 (via voltage regulator 366) upon receiving power from charging jack 370. HMD power source 376 provides power to the HMD device 2.

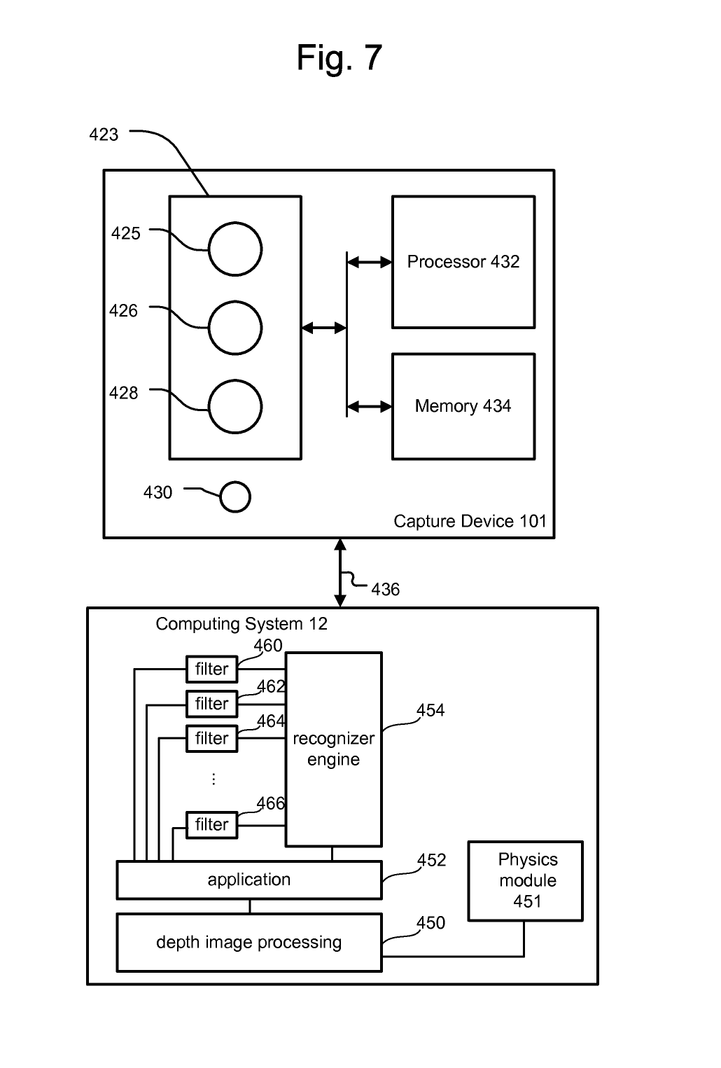

FIG. 7 illustrates an example embodiment of hub computing system 12 in communication with a capture device 101. The capture device 101 may be part of the HMD 2, but that is not required. According to an example embodiment, capture device 101 may be configured to capture depth information including a depth image that may include depth values via any suitable technique including, for example, time-of-flight, structured light, stereo image, or the like. According to one embodiment, the capture device 101 may organize the depth information into “Z layers,” or layers that may be perpendicular to a Z axis extending from the depth camera along its line of sight.

Capture device 101 may include a camera component 423, which may be or may include a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

Camera component 423 may include an infrared (IR) light emitter 425, an infrared camera 426, and an RGB (visual image) camera 428 that may be used to capture the depth image of a scene. A 3-D camera is formed by the combination of the infrared emitter 425 and the infrared camera 426. For example, in time-of-flight analysis, the IR light emitter 425 of the capture device 101 may emit an infrared light onto the scene and may then use sensors (in some embodiments, including sensors not shown) to detect the backscattered light from the surface of one or more targets and objects in the scene using, for example, the 3-D camera 426 and/or the RGB camera 428. According to one embodiment, time-of-flight analysis may be used to indirectly determine a physical distance from the capture device 101 to a particular location on the targets or objects by analyzing the intensity of the reflected beam of light over time via various techniques including, for example, shuttered light pulse imaging.

In another example embodiment, capture device 101 may use a structured light to capture depth information. In such an analysis, patterned light (i.e., light displayed as a known pattern such as grid pattern, a stripe pattern, or different pattern) may be projected onto the scene via, for example, the IR light emitter 425. Upon striking the surface of one or more targets or objects in the scene, the pattern may become deformed in response. Such a deformation of the pattern may be captured by, for example, the 3-D camera 426 and/or the RGB camera 428 (and/or other sensor) and may then be analyzed to determine a physical distance from the capture device to a particular location on the targets or objects. In some implementations, the IR light component 425 is displaced from the cameras 425 and 426 so triangulation can be used to determined distance from cameras 425 and 426. In some implementations, the capture device 101 will include a dedicated IR sensor to sense the IR light, or a sensor with an IR filter.

According to another embodiment, the capture device 101 may include two or more physically separated cameras that may view a scene from different angles to obtain visual stereo data that may be resolved to generate depth information. Other types of depth image sensors can also be used to create a depth image.

The capture device 101 may further include a microphone 430, which includes a transducer or sensor that may receive and convert sound into an electrical signal. Microphone 430 may be used to receive audio signals that may also be provided by hub computing system 12.

In an example embodiment, the video capture device 101 may further include a processor 432 that may be in communication with the image camera component 423. Processor 432 may include a standardized processor, a specialized processor, a microprocessor, or the like that may execute instructions including, for example, instructions for receiving a depth image, generating the appropriate data format (e.g., frame) and transmitting the data to hub computing system 12.

Capture device 101 may further include a memory 434 that may store the instructions that are executed by processor 432, images or frames of images captured by the 3-D camera and/or RGB camera, or any other suitable information, images, or the like. According to an example embodiment, memory 434 may include random access memory (RAM), read only memory (ROM), cache, flash memory, a hard disk, or any other suitable storage component. As shown in FIG. 7, in one embodiment, memory 434 may be a separate component in communication with the image capture component 423 and processor 432. According to another embodiment, the memory 434 may be integrated into processor 432 and/or the image capture component 423.

Capture device 101 is in communication with hub computing system 12 via a communication link 436. The communication link 436 may be a wired connection including, for example, a USB connection, a FireWire connection, an Ethernet cable connection, or the like and/or a wireless connection such as a wireless 802.11b, g, a, or n connection. According to one embodiment, hub computing system 12 may provide a clock to capture device 101 that may be used to determine when to capture, for example, a scene via the communication link 436. Additionally, the video capture device 101 provides the depth information and visual (e.g., RGB or other color) images captured by, for example, the 3-D camera 426 and/or the RGB camera 428 to hub computing system 12 via the communication link 436. In one embodiment, the depth images and visual images are transmitted at 30 frames per second; however, other frame rates can be used.

Hub computing system 12 includes depth image processing module 450. Depth image processing may be used to determine depth to various objects in the field of view (FOV).

Recognizer engine 454 is associated with a collection of filters 460, 462, 464, . . . , 466 each comprising information concerning a gesture, action or condition that may be performed by any person or object detectable by capture device 101. For example, the data from capture device 101 may be processed by filters 460, 462, 464, . . . , 466 to track the user's interactions with virtual objects 5.

The computing system 12 also has physics module 451. In one embodiment, the physics module 451 is able to render virtual images 5 that are based on physics simulations. The physics module 451 is able to propagate a real world property into a virtual image 5. The physics module 451 is able to determine how some physical property will influence the physics of the virtual image 5. For example, the physical property can be used as an input to a physics simulation. However, the virtual image 5 is not always generated using a physics simulation.

Capture device 101 provides RGB images (or visual images in other formats or color spaces) and depth images to hub computing system 12. The depth image may be a plurality of observed pixels where each observed pixel has an observed depth value. For example, the depth image may include a two-dimensional (2-D) pixel area of the captured scene where each pixel in the 2-D pixel area may have a depth value such as distance of an object in the captured scene from the capture device. Hub computing system 12 will use the RGB images and depth images to track a user's or object's movements. For example, the system may track a skeleton of a person using the depth images. There are many methods that can be used to track the skeleton of a person using depth images.

More information about recognizer engine 454 can be found in U.S. Patent Publication 2010/0199230, “Gesture Recognizer System Architecture,” filed on Apr. 13, 2009, incorporated herein by reference in its entirety. More information about recognizing gestures can be found in U.S. Patent Publication 2010/0194762, “Standard Gestures,” published Aug. 5, 2010, and U.S. Patent Publication 2010/0306713, “Gesture Tool” filed on May 29, 2009, both of which are incorporated herein by reference in their entirety.

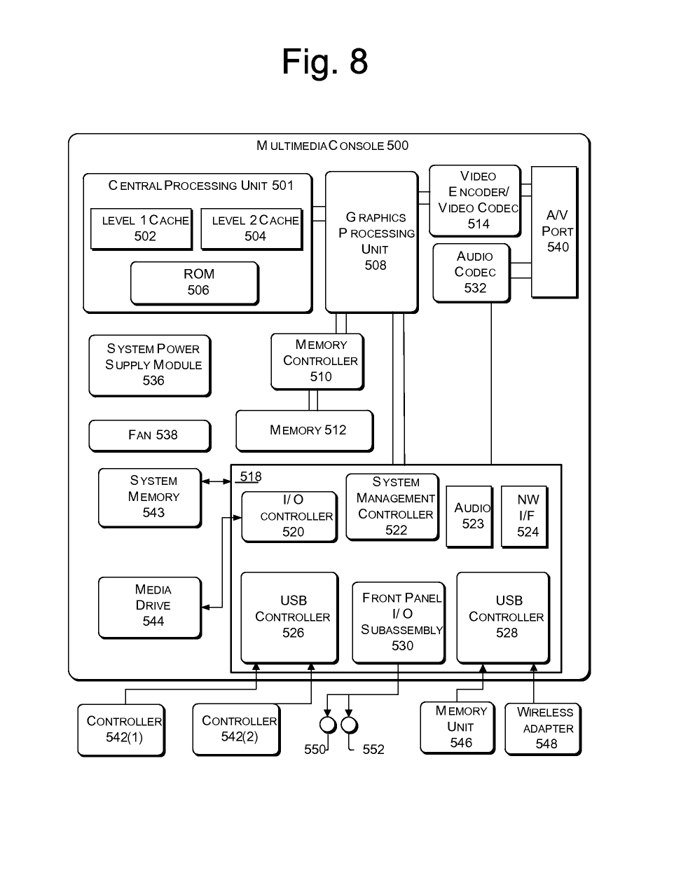

FIG. 8 illustrates an example embodiment of a computing system that may be used to implement hub computing system 12. As shown in FIG. 8, the multimedia console 500 has a central processing unit (CPU) 501 having a level 1 cache 502, a level 2 cache 504, and a flash ROM (Read Only Memory) 506. The level 1 cache 502 and a level 2 cache 504 temporarily store data and hence reduce the number of memory access cycles, thereby improving processing speed and throughput. CPU 501 may be provided having more than one core, and thus, additional level 1 and level 2 caches 502 and 504. The flash ROM 506 may store executable code that is loaded during an initial phase of a boot process when the multimedia console 500 is powered on.

A graphics processing unit (GPU) 508 and a video encoder/video codec (coder/decoder) 514 form a video processing pipeline for high speed and high resolution graphics processing. Data is carried from the graphics processing unit 508 to the video encoder/video codec 514 via a bus. The video processing pipeline outputs data to an A/V (audio/video) port 540 for transmission to a television or other display. A memory controller 510 is connected to the GPU 508 to facilitate processor access to various types of memory 512, such as, but not limited to, a RAM (Random Access Memory).

The multimedia console 500 includes an I/O controller 520, a system management controller 522, an audio processing unit 523, a network interface 524, a first USB host controller 526, a second USB controller 528 and a front panel I/O subassembly 530 that are preferably implemented on a module 518. The USB controllers 526 and 528 serve as hosts for peripheral controllers 542(1)-542(2), a wireless adapter 548, and an external memory device 546 (e.g., flash memory, external CD/DVD ROM drive, removable media, etc.). The network interface 524 and/or wireless adapter 548 provide access to a network (e.g., the Internet, home network, etc.) and may be any of a wide variety of various wired or wireless adapter components including an Ethernet card, a modem, a Bluetooth module, a cable modem, and the like.

System memory 543 is provided to store application data that is loaded during the boot process. A media drive 544 is provided and may comprise a DVD/CD drive, Blu-Ray drive, hard disk drive, or other removable media drive, etc. The media drive 544 may be internal or external to the multimedia console 500. Application data may be accessed via the media drive 544 for execution, playback, etc. by the multimedia console 500. The media drive 544 is connected to the I/O controller 520 via a bus, such as a Serial ATA bus or other high speed connection (e.g., IEEE 1394 serial bus interface).

The system management controller 522 provides a variety of service functions related to assuring availability of the multimedia console 500. The audio processing unit 523 and an audio codec 532 form a corresponding audio processing pipeline with high fidelity and stereo processing. Audio data is carried between the audio processing unit 523 and the audio codec 532 via a communication link. The audio processing pipeline outputs data to the A/V port 540 for reproduction by an external audio user or device having audio capabilities.

The front panel I/O subassembly 530 supports the functionality of the power button 550 and the eject button 552, as well as any LEDs (light emitting diodes) or other indicators exposed on the outer surface of the multimedia console 100. A system power supply module 536 provides power to the components of the multimedia console 100. A fan 538 cools the circuitry within the multimedia console 500.

The CPU 501, GPU 508, memory controller 510, and various other components within the multimedia console 500 are interconnected via one or more buses, including serial and parallel buses, a memory bus, a peripheral bus, and a processor or local bus using any of a variety of bus architectures. Such architectures can include a Peripheral Component Interconnects (PCI) bus, PCI-Express bus, etc.

When the multimedia console 500 is powered on, application data may be loaded from the system memory 543 into memory 512 and/or caches 502, 504 and executed on the CPU 501. The application may present a graphical user interface that provides a consistent user experience when navigating to different media types available on the multimedia console 500. In operation, applications and/or other media contained within the media drive 544 may be launched or played from the media drive 544 to provide additional functionalities to the multimedia console 500.

The multimedia console 500 may be operated as a standalone system by simply connecting the system to a television or other display. In this standalone mode, the multimedia console 500 allows one or more users to interact with the system, watch movies, or listen to music. However, with the integration of broadband connectivity made available through the network interface 524 or the wireless adapter 548, the multimedia console 500 may further be operated as a participant in a larger network community. Additionally, multimedia console 500 can communicate with processing unit 4 via wireless adaptor 548.

When the multimedia console 500 is powered ON, a set amount of hardware resources are reserved for system use by the multimedia console operating system. These resources may include a reservation of memory, CPU and GPU cycle, networking bandwidth, etc. Because these resources are reserved at system boot time, the reserved resources do not exist from the application's view. In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop ups) are displayed by using a GPU interrupt to schedule code to render a popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

After multimedia console 500 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 501 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager controls the gaming application audio level (e.g., mute, attenuate) when system applications are active.

Optional input devices (e.g., controllers 542(1) and 542(2)) are shared by gaming applications and system applications. The input devices are not reserved resources, but are to be switched between system applications and the gaming application such that each will have a focus of the device. The application manager preferably controls the switching of input stream, without knowing the gaming application's knowledge and a driver maintains state information regarding focus switches. In other embodiments, hub computing system 12 can be implemented using other hardware architectures. No one hardware architecture is required.

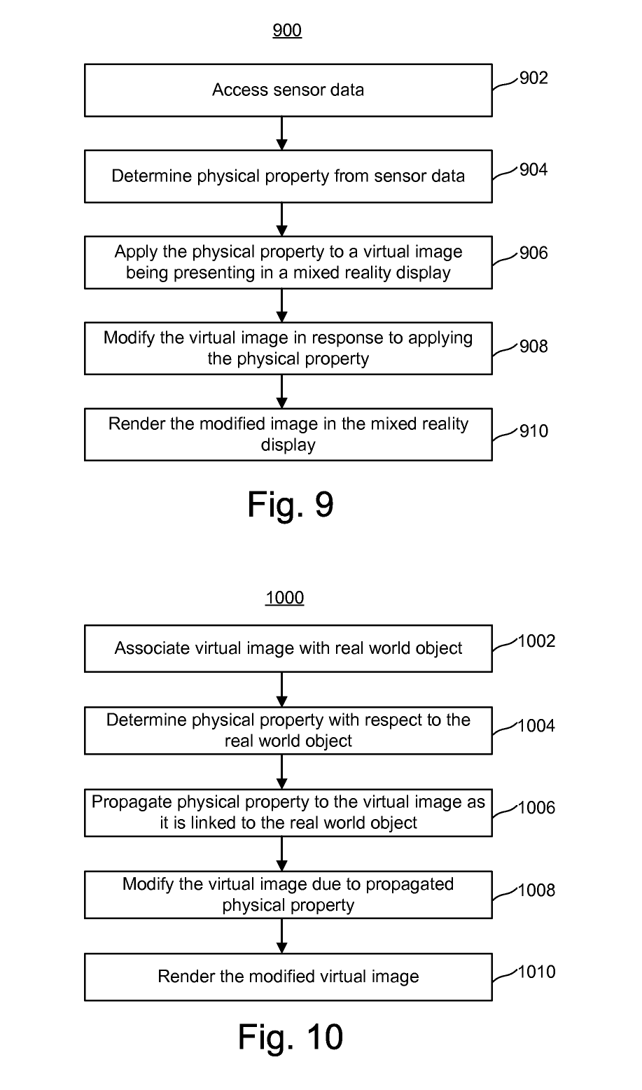

FIG. 9 is a flowchart of one embodiment of a process 900 of rendering a virtual image 5 in a see-through, near-eye, mixed reality display device 2. In process 900 a real world physical property may be propagated into the virtual image 5. In some embodiments, the virtual image 5 is linked to a real world object 7. Thus, changes in orientation on the real world object 7 may be transferred to the virtual image 5. Note that process 900 does not require for this linkage, although this linkage is one possibility.

In step 902, sensor data is accessed. The sensor data could be collected from any number or types of sensors. The sensors could be part of the see-through, near-eye, mixed reality display device 2, or associated with some other device. Example sensors associated with the see-through, near-eye, mixed reality display device 2 include a 3-axis magnetometer 132A, 3-axis gyro 132B, 3-axis accelerometer 132C, temperature sensor 138, microphone 110, light sensor 110, room facing camera 101. The front facing camera 101 can provide sensor data. The sensor data could come from another device such as a cellular telephone. Some cellular telephones may contain sensors that are able to determine their location (such as GPS sensors). Cellular telephones may also contain sensors such as, but not limited to, a 3-axis magnetometer, a 3-axis gyro, and a 3-axis accelerometer. Many other types of sensor data could be used.

In step 904, a physical property is determined based on the sensor data. In one embodiment, step 904 includes determining the physical property with respect to a real world object 7 that is associated with the virtual image 5. For example, a gravity vector is determined. Note that the gravity vector may be determined based on the present orientation of the real world object 7. Thus, in this example, the physical property (e.g., gravity vector) is not necessarily the same for all elements in the real world environment. As another example, the physical property could be forces other than gravity being applied to the real world object 7.

However, the physical property is not always necessarily specific to a real world object 7 (whether or not one is linked to the virtual object 5). As one example, the physical property may be the temperature in the environment of the mixed reality display 2. Of course, the temperature in the environment may in fact impact a real world object 7 linked to the virtual object 5. However, in this example, the temperature could well be independent of the real world object 7. Note that the temperature might be sampled by a sensor on the mixed reality device 2, which could well be a different temperature from a real world object 7 associated with the virtual image 5.

In step 906, the system 111 applies the physical property to the virtual image 5. In one embodiment, step 906 includes propagating a physical property (e.g., a physical force) into the virtual image 5. For example, the virtual image 5 may be driven, at least in part, by some physical property. One specific example is a physical simulation of a candle in which the physical property of a gravity vector is used to drive how the flame is rendered. The real world gravity vector can be used as an input parameter to the physics simulation. Note that when propagating a physical property there may be some scaling of the physical property. For example, if the real world physical property is a force of 35 Newtons, this could be scaled up or down depending on the nature of the virtual image 5 and the real world force.

Note that the step 906 does not require that the physical property be used as an input parameter to a physics simulation. The example of FIG. 1A-1C will be used as an example. In this case of the person traversing the rope, the physical property of a gravity vector is not necessarily input to a physical simulation in step 906. Rather, the gravity vector might be compared to the orientation of the rope as the step of applying the physical property to the virtual image 5.

In step 908, the system modifies the virtual image 5 in response to (or based on) applying the physical property. Referring to the example of the person traversing the rope, the gravity vector can be used to select which branch of a storyline is taken. For example, each of FIGS. 1A-1C may be considered to be different branches of a storyline. Further details are discussed below. As another example, if the physical property is light intensity, then the characters might light a candle if it becomes darker in the real world, or extinguish a candle if it becomes brighter in the real world. Referring to the example of FIGS. 2A-2C, the system 111 determines how the candle flame is affected by the change in the gravity vector.

In step 910, the system renders the virtual image 5 in the mixed reality display 2 based on how the physical property affects the physics of the image.

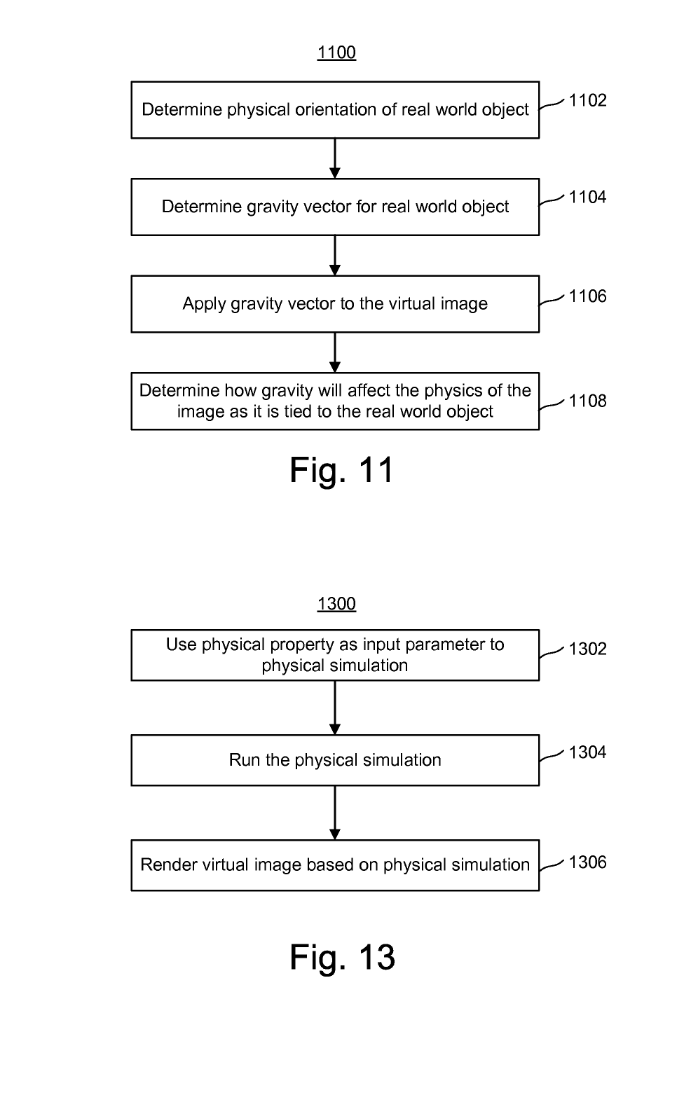

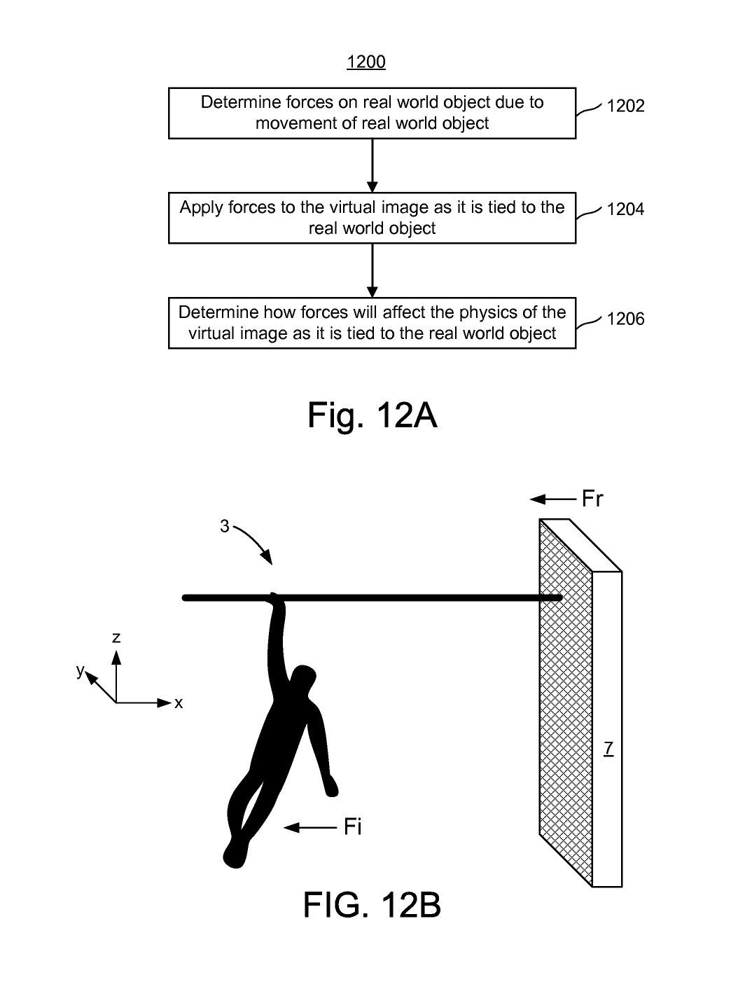

FIG. 10 is a flowchart of one embodiment of a process 1000 of rendering a virtual image 5 based on its connection to a real world physical object 7. Note that a virtual image 5 may also be referred to as an augmented reality scene. Process 1000 discusses an embodiment in which the virtual image 5 is linked to a real world object 7, and the physical property is related to the real world object 7. Process 1000 is one embodiment of steps 904-910 from process 900. Note that FIG. 11 below provide further details of one embodiment of FIG. 10, and FIG. 12A below provide further details of another embodiment of FIG. 10.

In step 1002, the virtual image 5 is associated with a real world object 7. This association may include a linkage of the virtual image 5 to some element of the real world object 7. For example, the virtual image 5 can be linked to a surface 8 of the real world object 7. By linked it is meant that when the real world object 5 moves that some aspect of the virtual image 5 tracks this movement. This may also be referred to as rooting the augmented reality scene to a surface of the real world object 7. In the example of FIGS. 1A-1C, the linkage is that the orientation of the rope stays the same relative to the surface 8. In the example of FIGS. 2A-2C, the linkage is that the base of the container for the candle stays on the surface 8 of the real world object 7. The foregoing examples are used for illustrative purposes. Note that the virtual image 5 can be linked to the real world object 7 in some other manner.

In step 1004, a physical property is determined with respect to the real world object 7. In one embodiment, the system 111 determines how a physical force acts upon the real world object 7. As one example, the system 111 determines a gravity vector with respect to the surface 8 of the real world object 7. FIG. 11 describes further details of one embodiment in which the physical property is a gravity vector.

As another example, the user might shake the real world object 7 to cause some effect on the virtual image 5. In this case, the system may determine (or estimate) the forces that act upon the real world object 7 due to the shaking. FIG. 12A describes further details of one embodiment in which the physical property is a result of movement of the real world object 7. Steps 1002-1004 are one embodiment of determining a physical property from sensor data (step 904 of process 900).

In step 1006, the system 111 propagates the physical property to the virtual image 5 as it is linked to the real world object 7. Step 1006 may include propagating the physical property into the virtual image 5. For example, a gravity vector may be propagated into the virtual image 5. Note that this is based on how the virtual image 5 is linked to the real world object 7. In one embodiment, step 1006 includes using the physical property as a parameter to a physics simulation. Step 1006 is one embodiment of step 906.

In step 1008, the system 111 modifies the virtual image 5 due to the propagated physical property. This step may include determining how the gravity vector should affect the virtual image 5, as one example. This might include selected a branch in a storyline. For example, the system 111 may determine that the person should be rendered as traversing horizontally along the rope (FIG. 1B), instead of climbing the rope (FIG. 1A). This might include determining results of a virtual simulation.

In step 1010, the system 111 renders the virtual image 5 based on how the physical property affects the real world object 7. As one example, once the effect the physical property has on the virtual image 5 is determined, the system 111 then determines how the virtual image should be rendered in response to the effect.

FIG. 11 is a flowchart of one embodiment of a process 1100 of determining how gravity in the environment will affect physics of a virtual image 5 that is linked to a real world object 7. Process 1100 is one embodiment of steps 1004-1008 of process 1000. Note that process 1100 is also one embodiment of steps 904-908 from process 900.

In step 1102, the system 111 determines the physical orientation of the real world object 7. The system 111 may use the forward facing cameras 101 of the mixed reality display device 2 to determine the orientation. As another alternative, this could be determined based on sensor data such as a 3-axis magnetometer, 3-axis gyro, 3-axis accelerometer in the real word object 7. In one embodiment, step 1102 is based on sensor data from the real world object 7. For example, a cellular telephone can have sensors that are able to determine its orientation.

In step 1104, the system 111 determines a gravity vector for the real world object 7, given its present orientation. FIGS. 1A-1C and 2A-2C show examples of a gravity vector and various orientations of the real world object 7. As noted, the direction of the gravity vector with respect to surface 8 may be determined, as one example. Steps 1102-1104 is one embodiment of step 904 from process 900. Steps 1102-1104 is also one embodiment of step 1004.

In step 1106, the system 111 applies the gravity vector to the virtual image, as it is linked to the real world object 7. Consider the example of the candle in FIGS. 2A-2C. If the real word object is as depicted in FIG. 2A, then the candle stick is oriented upwards (positive z-direction) and the gravity vector is directed downward (negative z-direction). If the real word object is as depicted in FIG. 2B, then the candle stick is oriented sideways (negative x-direction) and the gravity vector is directed downward (negative z-direction). Note that in this example, the candle stick is linked to the real world object 7. That is, the candle stick tracks position, as well as movement, of the real world object. However, the flame is a variable that does not track the real world object 7. Step 1106 is one embodiment of step 906. Step 1106 is also one embodiment of step 1006.

In step 1108, the system 111 determines how gravity will affect the physics of the virtual image 5. Again, consider the example of the candle in FIGS. 2A-2C. If the real word object 7 is as depicted in FIG. 2A, then the physics may dictate that the candle flame should burn upwards in response to the force of gravity. If the real word object 7 is as depicted in FIG. 2B, then the physics may dictate that the candle flame should burn upwards in response to the force of gravity. However, this alters the nature of the virtual image 5 as the orientation of the flame has changed relative to the candle stick. Note that this change in the physics of the virtual image 5 is made in response to the physical property (e.g., gravity).

If the real word object is as depicted in FIG. 2C, then the candle stick is oriented upside down (negative z-direction). In this case, the physics may dictate that the candle flame cannot be sustained. Again, this alters the nature of the virtual image relative to the other two cases. Note that this change in the physics of the virtual image 5 is made in response to the physical property (e.g., gravity). Step 1108 is one embodiment of step 908. Step 1108 is also one embodiment of step 1008.

FIG. 12A is a flowchart of one embodiment of a process 1200 of determining how forces on the real world object 7 due to movement of the object 7 will affect physics of the virtual image 5. Process 1200 is one embodiment of steps 1004-1008 of process 1000. Note that process 1200 is also one embodiment of steps 904-908 from process 900.

In step 1202, the system 111 determines forces on the real world object 7 due to movement of the real world object 7. As one example, the system 111 determines forces on the real world object 7 as the user shakes the real world object 7. In one embodiment, step 1202 is based on sensor data from the real world object 7. This could be determined based on sensor data such as a 3-axis magnetometer, 3-axis gyro, 3-axis accelerometer in the real word object 7. The system 111 could also use the forward facing cameras 101 of the mixed reality display device 2 to determine, or to help determine, the forces. Step 1202 is one embodiment of step 904 from process 900. Step 1202 is also one embodiment of step 1004.

In one embodiment, the system 111 determines the velocity of the real world object 7 using sensor data. This may be a vector that is updated an any desired time interval. Then, the system 111 either estimates the mass of the real world object 7 or creates a fictitious mass for the real world object 7 such that an force vector to apply to the image can be determined.

In step 1204, the system 111 applies forces to the virtual image 5, as it is linked to the real world object 7. FIG. 12B is a diagram of one embodiment of applying forces from a real world object 7 to a virtual image 5. The force vector \vec{F}r has been determined with respect to the real world object 7. This vector may be dynamic in this example of the use shaking the object 7. The virtual image vector \vec{F}i represents propagating the real world vector to the virtual image 5. In one embodiment, the system 111 assigns a mass (possibly distributing the mass appropriately) to the virtual image 5. Step 1204 is one embodiment of step 906. Step 1204 is also one embodiment of step 1006.

In step 1206, the system 111 determines how forces will affect the virtual image 5. Consider the example of the person traversing the rope in FIGS. 1A-1C. If the magnitude of the force from the shaking the real world object 7 is sufficient, then the person may be shaken off from the rope. Step 1206 could include performing a calculation to determine whether the virtual image vector \vec{F}i is sufficient to cause the person to fall off from the rope.

As noted, in process 1200, the real world forces are propagated into the virtual image 5. FIG. 12B shows a possible result of calculating a real world force vector \vec{F}r and applying a corresponding image force vector \vec{F}i to the virtual image 5. Note that the image force vector \vec{F}i may be scaled to have a different magnitude than the real world force vector \vec{F}r. The system 111 may determine that the image force vector \vec{F}i may cause the person to swing to the left. Therefore, this impact on the physics of the virtual image 5 may be used to determine how the virtual image 5 should be rendered. Step 1206 is one embodiment of step 908. Step 1206 is also one embodiment of step 1008.

Note that while the process 1200 of FIG. 12A discusses determining a force vector for the real world object 7, a similar effect can be achieved with determining and applying velocity or acceleration vectors. In one embodiment, the system 111 simply determines a velocity vector but does not determine a force vector for the real world object 7. The velocity vector (possibly scaled) may be applied to the image. For example, the system 111 may apply the velocity vector to the rope (e.g., parallel to rope in FIG. 12B). Then, the system 111 determines the affect that applying the velocity to the rope will have on the person on the rope. This final step may involve determining forces on the person represented in the image.

The system 111 could also determine an acceleration vector for the real world object 7. Then, the system 111 may apply the acceleration vector (possibly scaled) to the rope. Next, the system 111 determines the affect that applying the acceleration vector to the rope will have on the person on the rope. This final step may involve determining forces on the person represented in the image.

FIG. 13 is one embodiment of a flowchart of a process 1300 of rendering a virtual image based on a physical simulation that uses a real world physical property as an input. Process 1300 may be performed after determining a physical property from sensor data (step 904, FIG. 9). In one embodiment, physical properties regarding the surroundings of where the virtual image 5 is to appear to be in the real world is gathered. For example, the system 111 may determine whether the environment where the simulation to appear is it stone, metal, dirt word, etc.

1302, a real world physical property is used as an input to a physical simulation. For example, a gravity vector is input to a candle simulation. Step 1302 is one embodiment of step 906 of process 900.

In step 1304, the physical simulation is run. In one embodiment, the simulation allows the user to use their hand to create a virtual mountain by raising their hand over a flat surface. The mountain could consist of different simulation materials based on what it is created from. For example raising a mountain over a wooden surface creates foresty rain forest hills, raising it over metal creates exposed mine surfaces, raising it over sand creates virtual sand dunes, etc. Step 1304 is one embodiment of step 908 of process 900.

In step 1306, the system 111 renders a virtual image 5 based on results of the physical simulation. Step 1306 is one embodiment of step 910 of process 900.

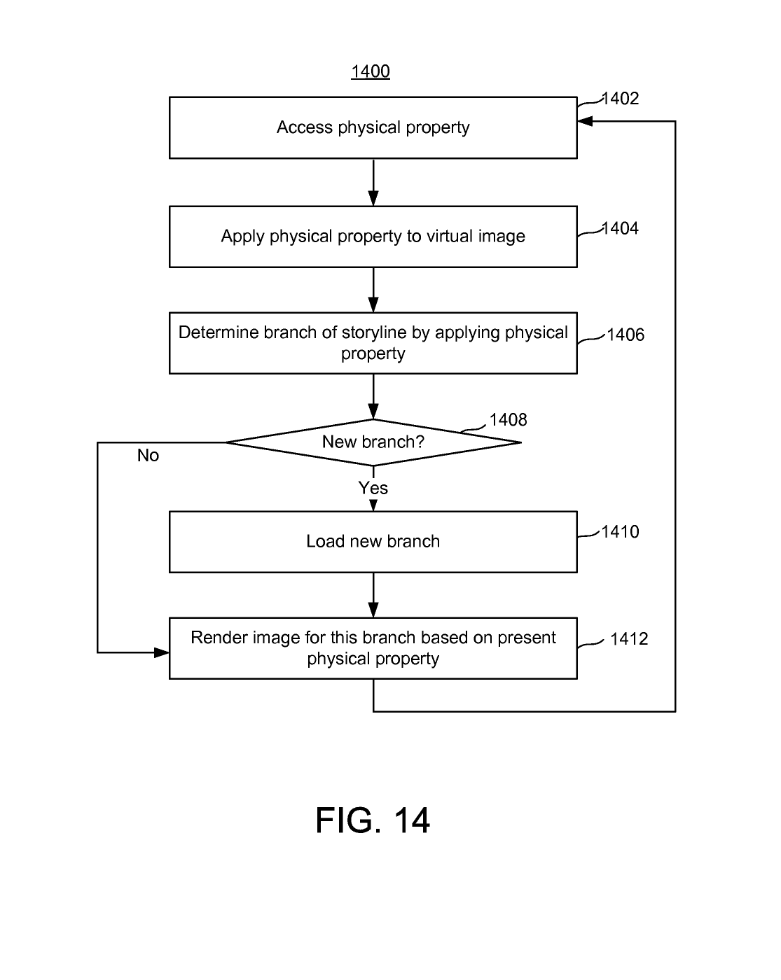

FIG. 14 is a flowchart of one embodiment of a process 1400 of rendering a virtual image 5 in which different branches are taken depending on a physical property in the environment.

Process 1400 will be discussed with respect to the example depicted in FIGS. 1A-1C, although process 1400 is not so limited. In this example, there are three branches. The first branch corresponds to the person climbing in FIG. 1A. The second branch corresponds to the person traversing sideways in FIG. 1B. The third branch corresponds to the person repelling down, as shown in FIG. 1C. These could be considered to be three branches of a storyline or of a simulation. Note that in this example, the basic storyline of a person traversing a rope is kept intact. The aspect that the person traverses in a direction away from the surface 8 may also be kept intact.

In step 1402, a physical property is accessed. For purposes of discussion, the physical property of a gravity vector will be discussed. However, the physical property could be something else. The gravity vector may be relative to the real world object 7. For example, it could be relative to a surface 8 of the real world object 7. Step 1402 is one embodiment of step 904 of process 900.

In step 1404, the physical property is applied to the virtual image 5. For example, the gravity vector is applied to the virtual image 5, given how the virtual image 5 is orientated. As noted, the orientation of the virtual image 5 may be linked to the orientation of the real world object 7. Step 1404 is one embodiment of step 906 of process 900.

In step 1406, a branch of the storyline is determined. If the gravity vector is pointing down into the surface 8 of the real world object 7, then branch A could be selected. This corresponds to the example of FIG. 1A. If the gravity vector is parallel to the surface 8 of the real world object 7, then branch B could be selected. This corresponds to the example of FIG. 1B. If the gravity vector is pointing away from the surface 8 of the real world object 7, then branch C could be selected. This corresponds to the example of FIG. 1C.

Note that determining the branch of the storyline is one embodiment of determining how the physical property affects the physics of the virtual image 5 (step 906, FIG. 9). As previously discussed, the virtual image 5 is linked to the real world object 7, in one embodiment. In this example, the direction of the rope in the virtual image 5 is physically linked to the orientation of the surface 8 of the real world object. Thus, note that the direction of the gravity vector relative to the rope may be used to select which branch is taken. However, in some cases there may not be a specific portion of the virtual image 5 that remains physically linked to the real world object 7.

In step 1408, a determination is made whether this is a new branch of the storyline. If so, then the system loads the new branch of the storyline in step 1410. For example, the system 111 might be presently rendering the storyline of branch A in which the person is climbing the rope (FIG. 1A). However, upon determining that the gravity vector is substantially parallel to the surface 8 of the real world object 7, the system 111 determines that branch B in which the person is traversing the rope horizontally should be loaded.

In step 1412, the system 111 renders the virtual image 5 for whatever branch is presently loaded. This may include showing the person traversing the rope from right to left, as one example. This branch of the storyline may continue until it is determined that a new branch should be loaded. Step 1412 is one embodiment of step 910 of process 900.

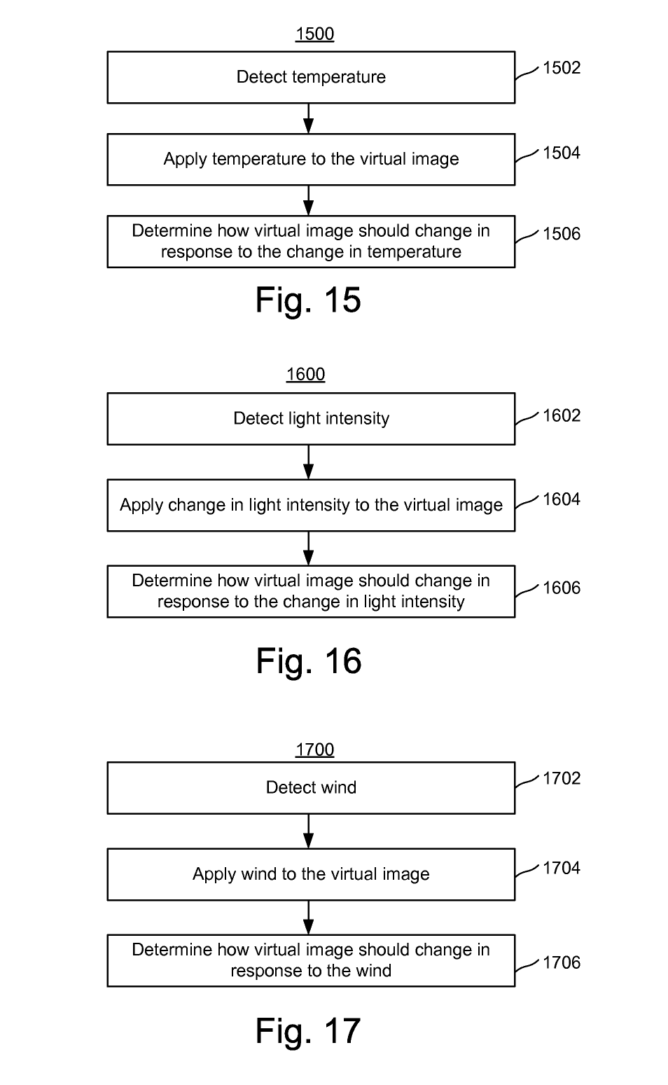

FIG. 15 is a flowchart of one embodiment of a process 1500 of determining an effect of temperature on a virtual image 5. Process 1500 is one embodiment of steps 902-908 from process 900. In step 1502, temperature is detected. This may be detected with a temperature sensor 138 on the mixed reality display device 2. The sensor could be on a different device. Step 1502 is one embodiment of steps 902-904.

In step 1504, the temperature is applied to the virtual image 5. As one example, the virtual image 5 may include an augmented reality scene that includes various plants. As one example, the hot temperature may be applied to the augmented reality scene that includes various plants. Note that this step 1504 may be performed internally by the system 111 without yet displaying an effect in the mixed reality display 2. Also note that step 1504 may be considered to be applying the temperature to the physics of the virtual image 5. Step 1504 is one embodiment of step 906.

In step 1506, a temperature effect on the virtual image 5 is determined. In the present example, the virtual image 5 may include an augmented reality scene that includes various plants. If the temperature is very hot, then effect to the virtual image 5 may be for the plants to wilt. As another example, hotter climates may tend support certain plants but not others. For example, a hot dry climate may support cactus, but not deciduous trees. The system 111 may determine that if such a hot temperature were to be maintained for a sustained time period, then deciduous trees would not likely survive. In other words, the reasoning may go as follows. Initially, the virtual image 5 is of a deciduous forest. The system 111 determines that the temperature is 98 degrees F. The system 111 may determine that the long term effect is that the deciduous forest would not survive, and might be replaced by a desert scene with cactus. Step 1506 is one embodiment of step 908. Note that the effect determined in step 1506 may be rendered in step 910 of process 900.

FIG. 16 is a flowchart of one embodiment of a process 1600 of determining an effect of a light intensity on a virtual image 5. Process 1600 is one embodiment of steps 902-908 from process 900. In step 1602, light intensity is detected. This may be detected with a light sensor 119 on the mixed reality display device 2. The sensor could be on a different device. Step 1602 is one embodiment of steps 902-904.

In step 1604, the light intensity is applied to the virtual image 5. As one example, the virtual image 5 may be of a group of people. Applying the light intensity may include reducing the intensity of light. Note that this step does not necessarily include displaying any effect in the mixed reality display 2 at this point. Rather, this step may be performed by the system 111 internally. Step 1604 is one embodiment of step 906. Also note that step 1604 may be considered to be applying the light intensity to the physics of the virtual image 5.

In step 1606, the effect that light intensity has on the virtual image 5 is determined. In the present example, the virtual image 5 is a group of people. If the light intensity diminishes, then the effect could be for someone in the group to light a candle. If the light intensity increases, then the effect could be for someone in the group to extinguish a candle. Step 1606 is one embodiment of step 908. Note that this effect may be rendered in step 910 of process 900.

FIG. 17 is a flowchart of one embodiment of a process 1700 of determining an effect of a wind on a virtual image 5. Process 1700 is one embodiment of steps 902-908 from process 900. In step 1702, wind is detected. This may include determining a wind vector having a force and a magnitude. Step 1702 is one embodiment of steps 902-904.

In step 1704, the wind vector is applied to the virtual image 5. Applying the wind vector may include inputting a wind vector into a physical simulation, as one example. Note that this step does not necessarily include displaying any effect in the mixed reality display 2 at this point. Rather, this step may be performed by the system 111 internally. Step 1704 is one embodiment of step 906. Also note that step 1704 may be considered to be applying the wind vector to the physics of the virtual image 5.

In step 1706, the effect that wind has on the virtual image 5 is determined. As one example, this determination may be made by running a physical simulation in which the wind vector is applied. For example, the wind vector may cause the direction of a flag blowing in a physical simulation to change. However, note that a physical simulation does not need to be run in step 1706. As another example, the system 111 can determine that on a windy day characters in a scene might put on an extra layer of clothes to block the wind. Step 1706 is one embodiment of step 908. Note that this effect may be rendered in step 910 of process 900.

In some embodiments, one or more steps of any of the processes described herein may be performed by executing instructions on one or more processors. Processors may access instructions that are stored on a variety of computer readable media. Computer readable media can be any available media that can be accessed by the processor and includes both volatile and nonvolatile media, removable and non-removable media. By way of example, and not limitation, computer readable media may comprise computer storage media. A computer storage device is one example of computer readable media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by processors. Combinations of the any of the above should also be included within the scope of computer readable media.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method comprising:
determining a physical property based on sensor data;
applying the physical property to a virtual image;
modifying the virtual image in response to applying the physical property; and
rendering the modified virtual image in a see-through, near-eye, mixed-reality display device.

2. The method of claim 1, further comprising:
associating the virtual image with a real world object, the determining a physical property based on sensor data includes determining the physical property with respect to the real world object, the applying the physical property to a virtual image includes propagating the physical property with respect to the real world object to the virtual image.

3. The method of claim 2, wherein the associating the virtual image with a real world object includes:
linking the virtual image to an element of the real world object.

4. The method of claim 2, wherein the determining the physical property based on sensor data includes determining gravity and movement forces acting on the real world object.

5. The method of claim 1, wherein the virtual image includes a storyline having branches, the modifying the virtual image in response to applying the physical property includes:
determining which of the branches to take based on how the applied physical property affects the virtual image.

6. The method of claim 5, wherein the rendering the modified virtual image in a see-through, near-eye, mixed-reality display device includes:
rendering the branch of the storyline that was determined based on how the applied physical property affects the virtual image.

7. The method of claim 1, wherein the virtual image includes a physical simulation that is driven by the physical property, the applying the physical property to a virtual image includes applying the physical property as a parameter to the physical simulation.

8. The display system of claim 1, wherein the applying the physical property to a virtual image includes propagating forces associated with a real world object into the virtual image.

9. A display system comprising:
a see-through, near-eye mixed reality display device;
logic in communication with the display device, the logic is configured to:
determine a physical property based on sensor data;
propagate the physical property to an augmented reality scene;
modify the augmented reality scene based on the propagated physical property; and
render the modified augmented reality scene in the see-through, near-eye, mixed-reality display device.

10. The display system of claim 9, wherein the logic is further configured to:
link the augmented reality scene with a real world object; and
determine the physical property with respect to the real world object, the logic propagates the physical property to the augmented reality scene based on its linkage to the real world object.

11. The display system of claim 10, wherein the logic being configured to determine the physical property with respect to the real world object includes the logic being configured to:
determine changes in location and/or orientation of the real world object.

12. The display system of claim 10, wherein the logic is further configured to:
determine a physical orientation of the real world object, the logic being configured to determine the physical property with respect to the real world object includes the logic being configured to determine a gravitational vector with respect to a surface of the real world object in the determined physical orientation.

13. The display system of claim 9, wherein the augmented reality scene includes a storyline having branches, the logic being configured to modify the augmented reality scene based on the propagated physical property includes the logic being configured to:
determine how the propagated physical property affects physics of the image; and
determine which branch to take based on how the physics of the image is affected.

14. The display system of claim 9, wherein the virtual image is based on a physical simulation that is driven by the physical property, the logic is configured to use the physical property as an input parameter to the physical simulation.

15. A method comprising:
rendering an augmented reality scene in a head mounted display device;
associating the augmented reality scene with a real world object;
accessing sensor data of an environment of the head mounted display device;
determining, based on the sensor data, a physical force that affects the real world object;
propagating the physical force to the augmented reality scene;
modifying the augmented reality scene due to the propagated physical force; and
rendering the modified augmented reality scene in the head mounted display device.

16. The method of claim 15, wherein the associating the augmented reality scene with a real world object includes:
rooting the augmented reality scene to a surface of the real world object.

17. The method of claim 15, wherein the augmented reality scene includes a storyline having branches, the modifying the augmented reality scene due to the propagated physical force includes:
determining which of the branches to take based on how the propagated physical force affects the augmented reality scene.

18. The method of claim 15, wherein the augmented reality scene includes a physical simulation that is driven by the physical force, the propagating the physical force to the augmented reality scene and the modifying the augmented reality scene due to the propagated physical force includes:
inputting the physical force as a parameter that drives to the simulation; and
running the simulation.

19. The method of claim 15, further comprising:
determining temperature, light intensity, or wind in an environment near the see-through, near-eye, mixed-reality display device;
propagating the temperature, light intensity, or wind into the augmented reality scene; and
rendering the augmented reality scene in the head mounted display device based on results of the propagated temperature, light intensity, or wind.

20. The method of claim 19, further comprising:
determining an impact to a storyline in the augmented reality scene based on the propagated temperature, light intensity, or wind.
